(19) United States
(12) Patent Application Publication
(10) Pub. No.: US 2017/0154205 A1
(43) Pub. Date: Jun. 1, 2017

(54) METHOD AND APPARATUS FOR CLOSING A TERMINAL

(71) Applicants: LE HOLDINGS (BEIJING) CO., LTD., Beijing (CN); LE SHI ZHI XIN ELECTRONIC TECHNOLOGY (TIAN JIN) LIMITED, Tianjin (CN)

(72) Inventors: Junjie ZHAO, Tianjin (CN); Yan YU, Tianjin (CN); Han XIAO, Tianjin (CN)

(21) Appl. No.: 15/242,647

(22) Filed: Aug. 22, 2016

Related U.S. Application Data
(63) Continuation of application No. PCT/CN2016/082500, filed on May 18, 2016.

(30) Foreign Application Priority Data
Nov. 27, 2015 (CN) 201510852146.3

(51) Int. Cl. G06K 9/00; G06K 9/46

(52) U.S. Cl. CPC G06K 9/00228; G06K 9/4671

(57) ABSTRACT

Disclosed are a method and apparatus for closing a terminal, where a terminal acquires in real time an image in a preset range around the terminal, and if there is no human facial image detected in the acquired image, then the terminal will start a timer; and if a length of time recorded by the timer reaches a first preset length of time, and there is no human facial image detected in the image acquired throughout the length of time recorded by the timer, then the terminal will be closed.

### CROSS-REFERENCE TO RELATED APPLICATIONS

This application is a continuation of International Application No. PCT/CN2016/082500, filed on May 18, 2016, which claims priority to Chinese Patent Application No. 201510852146.3, filed on Nov. 27, 2015, both of which are hereby incorporated by reference in their entireties.

### TECHNICAL FIELD

Embodiments of the disclosure relate to the field of communications, and particularly to a method and apparatus for closing a terminal.

### BACKGROUND

Various terminals (e.g., a handset, a PAD, etc.) have been widely applied due to their rapid communications and convenient operations along with the development of the Internet. At present, the terminals can be provided with separate operating systems, and their users can install applications available from third-party service providers as needed to thereby extend the functions of the terminals due to the applications.

At present, in order to save power consumption of a terminal, if the terminal is active, then the terminal will be typically configured so that if the terminal has not received any operating instruction when a preset length of time elapses since the terminal is activated, then the terminal will be closed so that the terminal may be hibernated or powered offt where the preset length of time is a manually preset length of time. With this technical solution, if the terminal is running some specific application, then if the user has been absent from the terminal due to some reason without closing the terminal, then the terminal will remain active all the time. For example, if the terminal is running a video playing application, then if the user does not close the application, then the terminal will be playing a video all the time, thus consuming more power, and consequently shortening the length of time for which the terminal is operating with its battery.

As can be apparent, there is the problem of high power consumption in the existing terminal.

### SUMMARY

Embodiments of the disclosure provide a method and apparatus for closing a terminal so as to address the problem of high power consumption in the existing terminal.

Particular technical solutions according to the embodiments of the disclosure are as follows:

Some embodiments of the disclosure provide a method for closing a terminal, the method includes:
acquiring, by the terminal, in real time an image in a preset range;
starting, by the terminal, a timer if there is no human facial image detected in the acquired image; and
closing, by the terminal, if a length of time recorded by the timer reaches a first preset length of time, and there is no human facial image detected in the image acquired throughout the length of time recorded by the timer.

Some embodiments of the disclosure provide an apparatus for closing a terminal, the apparatus includes: at least one processor; and
a memory communicably connected with the at least one processor for storing instructions executable by the at least one processor, wherein execution of the instructions by the at least one processor causes the at least one processor to:
acquire in real time an image in a preset range;
start a timer if there is no human facial image detected in the acquired image; and
close the terminal if a length of time recorded by the timer reaches a first preset length of time, and there is no human facial image detected in the image acquired throughout the length of time recorded by the timer.

Some embodiments of the disclosure provide a non-transitory computer-readable storage medium storing executable instructions that are set to:
acquire in real time an image in a preset range;
start a timer if there is no human facial image detected in an acquired image; and
close the terminal if a length of time recorded by the timer reaches a first preset length of time, and there is no human facial image detected in the image acquired throughout the length of time recorded by the timer.

With the method and apparatus for closing a terminal according to the embodiments of the disclosure, the terminal acquires in real time the image in the preset range around the terminal, and if there is no human facial image detected in the acquired image, then the terminal will start the timer; and if the length of time recorded by the timer reaches the first preset length of time, and there is no human facial image detected in the image acquired throughout the length of time recorded by the timer, then the terminal will be closed. With the technical solutions according to the embodiments of the disclosure, the terminal detects a human facial image in the preset range using the human face recognition function, and if there is no human facial image detected throughout the first preset of time, then the terminal will be closed, so that even if the user does not close the terminal, the terminal can be closed automatically in response to the human face recognition result to thereby save power consumption of the terminal so as to extend the operating period of time and the service lifetime of the battery.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of closing a terminal according to a first embodiment of the disclosure;

FIG. 2 is a flow chart of closing a terminal according to a second embodiment of the disclosure;

FIG. 3 is a schematic structural diagram of an apparatus for closing a terminal according to a third embodiment of the disclosure; and

FIG. 4 is a schematic structural diagram of a terminal according to a fburth embodiment of the disclosure; and

FIG. 5 is a schematic structural diagram of an apparatus for closing a terminal according to some embodiments of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

The embodiments of the disclosure will be described below in further details with reference to the drawings.

In the embodiments of the disclosure, a terminal is a device capable of communication, and provided with a user interaction interface, e.g., an intelligent TV set, a personal computer, a handset, a tablet computer, etc., and an operating system loaded in the terminal can be the Windows operating system, the Android operating system, the ios operating system, etc.

### First Embodiment

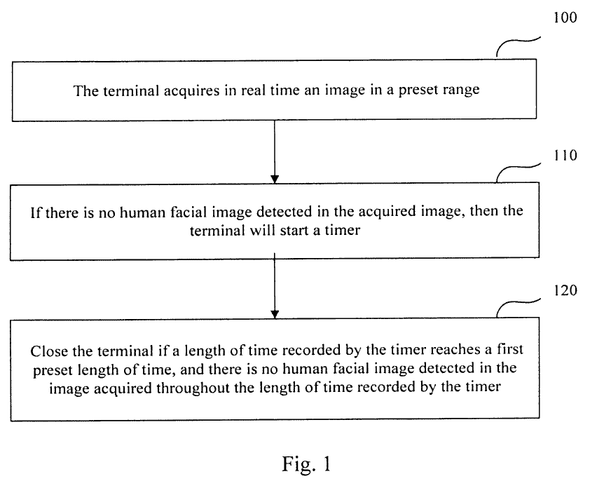

Referring to FIG. 1, a process of closing a terminal according to some embodiments of the disclosure includes:

In the step 100, the terminal acquires in real time an image in a preset range.

In some embodiments of the disclosure, the terminal acquires in real time an image in a preset range upon detecting that the current operating state thereof satisfies a preset condition.

Optionally the terminal detects that the current operating state thereof satisfies the preset condition as follows: the terminal determines a job at the current instance of time, and if the job does not belong to a preset set of jobs, then the flow will proceed to the step of acquiring in real time the image in the preset range, where elements in the set of jobs are values preset for particular application scenarios, for example, the set of jobs includes video playing, and other elements; and/or the terminal determines a point of time when an instruction was received most lately prior to the current instance of time, and if the length of time from the recorded point of time to the current instance of time is more than a second preset length of time, then the flow will proceed to the step of acquiring in real time the image in the preset range, for example, if the second preset length of time is 30 minutes, then if the terminal receives an audio playing instruction at 8:20, and detects at 8:51 that the terminal has not received any instruction from 8:20 to 8:51, then the difference of time between the current instance of time and the point of time when the terminal received the instruction most lately prior to the current instance of time will reach the second preset length of time, so the terminal can acquire in real time the image in the preset range, where the second preset length of time is a value preset manually for a particular application scenario.

Optionally the terminal acquires the image in the preset range using a photographing device which is a photo camera or a video camera. Moreover there is a wide angle of view on the terminal, that is, the user can not recognize any image on the terminal beyond the wide angle of view on the terminal, so optionally the preset range is a range lying within the wide angle of view on the terminal, and the preset range further includes an observation radius centered on the terminal, where the observation radius is a value preset as a function of the size of a screen of the terminal; and optionally if the screen of the terminal is larger, then the observation radius will be longer, and if the screen of the terminal is smaller, then the observation radius will be shorter.

In the step 110, if there is no human facial image detected in the acquired image, then the terminal will start a timer.

In some embodiments of the disclosure, the terminal detects the image acquired in real time for a human facial image, and if there is a human facial image detected in the image, then no operation will be performed on the terminal, and the terminal will maintain the current state or perform the current operation; and if there is no human facial image detected in the acquired image, then the timer will be started.

Optionally the terminal detects the acquired image for a human facial image by eliminating another interference graphs than a human face in the acquired image using a facial sub-feature technology to thereby remove an interference factor in the image so as to ensure the accuracy of subsequently recognizing a human facial image, thus avoiding the terminal from performing an improper operation in response to a wrong recognition result; and since there are such facial features of a person in a human facial image that have corresponding values satisfying preset conditions, if facial feature values satisfying preset conditions can be extracted from the image from which the interference graphs is eliminated, then there will be a human facial image in the acquired image; otherwise, there will be no human facial image in the acquired image.

Optionally the facial feature values are extracted from the image from which the interference graphs is eliminated, by extracting feature points in the image, and contours corresponding to the feature points, where the feature points include at least the eyes, the nose, and the mouth, and the contours corresponding to the respective feature points define closed areas; and determining the sizes of the areas surrounded by the respective extracted contours respectively, the positions of the respective feature points, and the distances between respective two feature points as the facial feature values in the image.

It is determined that the facial feature values satisfy the preset conditions, by determining that the facial feature values satisfy the preset conditions if the sizes of the areas surrounded by the respective contours lie in corresponding preset area ranges respectively, the positions of the respective feature points lie in corresponding preset feature point ranges respectively, and the distances between the respective two feature points lie in corresponding distance ranges respectively. For example, if a feature point is the eyes including the left eye positioned at (x1,y1), and the right eye positioned at (x2,y2), then the distance between the left eye and the right eye (represented as b) will be calculated, and an offset can be calculated in the equation of:

b=\sqrt{(x1−x2)²+(y1−y2)²},

Where it is determined whether b lies in a preset distance range represented as [b1, b2].

The step 120 is to close the terminal if a length of time recorded by the timer reaches a first preset length of time, and there is no human facial image detected in the image acquired throughout the length of time recorded by the timer.

In some embodiments of the disclosure, the terminal determines a length of time recorded by the timer, and if the length of time does not reach a first preset length of time, and there is no human facial image detected in the image acquired throughout the length of time recorded by the timer, then the timer will continue with counting, and the terminal will maintain the current operating state; if the length of time does not reach the first preset length of time, and there is a human facial image detected in the image acquired in the length of time recorded by the timer, then the timer will be reset to zero, and the terminal will return to the step 100; and if the length of time reaches the first preset length of time, and there is no human facial image detected in the image acquired throughout the length of time recorded by the timer, then the terminal will be closed so that the terminal may be hibernated or powered off or kept silent; and the preset length of time is a manually preset length of time.

With the technical solution above, the terminal detects a human facial image in the preset range using the human face recognition function, and if there is no human facial image detected throughout the first preset of time, then the terminal will be closed, so that even if the user does not close the terminal, then the terminal can be closed automatically in response to the human face recognition result to thereby save power consumption of the terminal so as to extend the operating period of time and the service lifetime of a battery.

### Second Embodiment

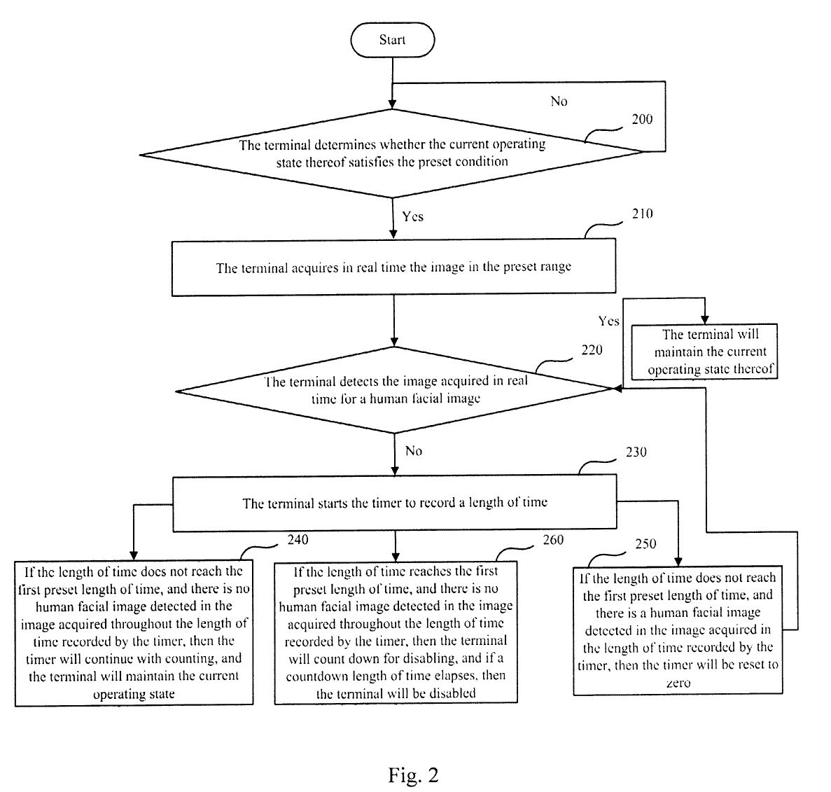

Further to the technical solution according to the first embodiment, referring to FIG. 2, a process of closing the terminal will be described below in details in connection with a particular application scenario.

In the step 200, the terminal determines whether the current operating state thereof satisfies the preset condition, and if so, then the flow will proceed to the step 210; otherwise, the terminal will further determine whether the current operating state thereof satisfies the preset condition.

In some embodiments of the disclosure, the terminal determines whether the current operating state thereof satisfies the preset condition by determining a job at the current instance of time, and determining whether the job is in a preset set of jobs; and/or by determining a point of time when an instruction was received most lately prior to the current instance of time, and determining whether the length of time from the recorded point of time to the current instance of time is more than a second preset length of time.

In the step 210, the terminal acquires in real time the image in the preset range.

In the step 220, the terminal detects the image acquired in real time for a human facial image, and if there is a human facial image detected in the image, then the terminal will maintain the current operating state thereof; otherwise, the flow will proceed to the step 230.

In the step 230, the terminal starts the timer to record a length of time.

The step 240, if the length of time does not reach the first preset length of time, and there is no human facial image detected in the image acquired throughout the length of time recorded by the timer, then the timer will continue with counting, and the terminal will maintain the current operating state.

In the step 250, if the length of time does not reach the first preset length of time, and there is a human facial image detected in the image acquired in the length of time recorded by the timer, then the timer will be reset to zero, and the terminal will return to the step 220.

In the step 260, if the length of time reaches the first preset length of time, and there is no human facial image detected in the image acquired throughout the length of time recorded by the timer, then the terminal will count down for closing, and if a countdown length of time elapses, then the terminal will be closed.

### Third Embodiment

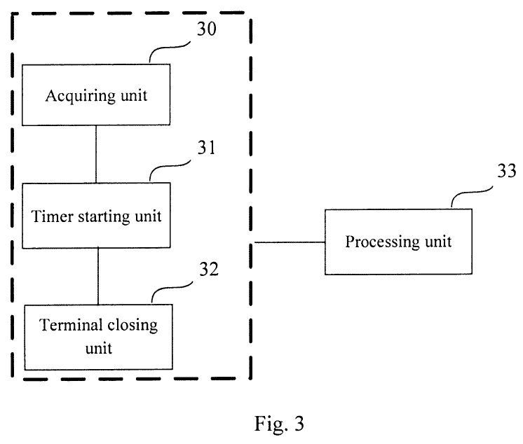

Further to the technical solutions according to the first embodiment and the second embodiment, referring to FIG. 3, some embodiments of the disclosure further provide an apparatus for closing a terminal, the apparatus includes an acquiring unit 30, a timer starting unit 31, and a terminal closing unit 32, where:

The acquiring unit 30 is configured to acquire in real time an image in a preset range;

The timer starting unit 31 is configured to start a timer if there is no human facial image detected in the acquired image; and

The terminal closing unit 32 is configured to close the terminal if a length of time recorded by the timer reaches a first preset length of time, and there is no human facial image detected in the image acquired throughout the length of time recorded by the timer.

Optionally the apparatus further includes a processing unit 33 configured, before the image in the preset range is acquired in real time, to determine a job at the current instance of time, and if the job does not belong to a preset set of jobs, to instruct the acquiring unit 30 to acquire the image in the preset range in real time; and/or to determine a point of time when an instruction was received most lately prior to the current instance of time, and if the length of time from the recorded point of time to the current instance of time is more than a second preset length of time, to instruct the acquiring unit 30 to acquire the image in the preset range in real time.

Optionally the processing unit 33 configured to detect a human facial image in the acquired image is configured: to eliminate another interference graphs than a human face in the acquired image using a facial sub-feature technology; and if facial feature values satisfying preset conditions can be extracted from the image from which the interference graphs is eliminated, to determine that there is a human facial image in the acquired image, otherwise, to determine that there is no human facial image in the acquired image.

Optionally the processing unit 33 configured to extract the facial feature values from the image from which the interference graphs is eliminated is configured: to extract feature points in the image, and contours corresponding to the feature points, where the feature points include at least the eyes, the nose, and the mouth, and the contours corresponding to the respective feature points define closed areas; and to determine the sizes of the areas surrounded by the respective extracted contours respectively, the positions of the respective feature points, and the distances between respective two feature points as the facial feature values in the image.

Optionally the processing unit 33 configured to determine that the facial feature values satisfy the preset conditions is configured to determine that the facial feature values satisfy the preset conditions if the sizes of the areas surrounded by the respective contours lie in corresponding preset area ranges respectively, the positions of the respective feature points lie in corresponding preset feature point ranges respectively, and the distances between the respective two feature points lie in corresponding distance ranges respectively.

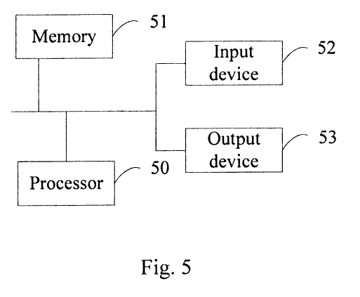

Further to the technical solutions according to the first embodiment and the second embodiment, referring to FIG. 5, some embodiments of the disclosure provide an apparatus for closing a terminal; the apparatus includes one or more processors 50 and a memory 51. FIG. 5 takes an example of one processor 50.

The apparatus further includes an input device 52 and an output device 53.

The processor 50 and the memory 51 can be connected together by a bus of other connections. The FIG. 5 takes an example of bus connection.

The memory 51 serves as a non-transitory computer-readable storage medium for storing non-transitory programs, non-transitory computer-executable instructions and modules, such as some modules for performing the method for closing a terminal according to some embodiments of the disclosure (e.g. units as shown in FIG. 3). The processor 50 performs the method for closing a terminal according to some embodiments of the disclosure by executing the non-transitory programs, instructions and modules.

The memory 51 can have a program-storing partition and a data-storing partition. Here the program-storing partition can store operation systems, at least one application for performing a certain function. The data-storing partition can store data generated by operation of the apparatus. Further, the memory 51 can be high-speed RAM, and also non-transitory memory, such as at least one magnetic disk memory device, flash memory or any other non-transitory solid memory device. In some embodiments, the memory 51 can be a remote memory which is arranged in a manner that is away from the processor 51. The remote memories can connected to the electronic device via network, of which instances include but not limit to internet, intranet, LAN, mobile radio communications and combination thereof.

The input device 51 can receive inputted digital or character information, and generate signal inputs concerning user setup and function control of the apparatus. The output device 53 can be display screen and other display devices.

At least one of the modules is stored in the memory 51. When at least one of the modules is executed by the at least one processor 50, it performs the aforementioned method for closing a terminal.

The aforementioned apparatus can execute the method according to some embodiments of the disclosure, and has functional modules for executing corresponding method and advantageous thereof. For more technical details, the method according to some embodiments of the disclosure can be referred.

The apparatus according to some embodiments of the disclosure are in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

### Fourth Embodiment

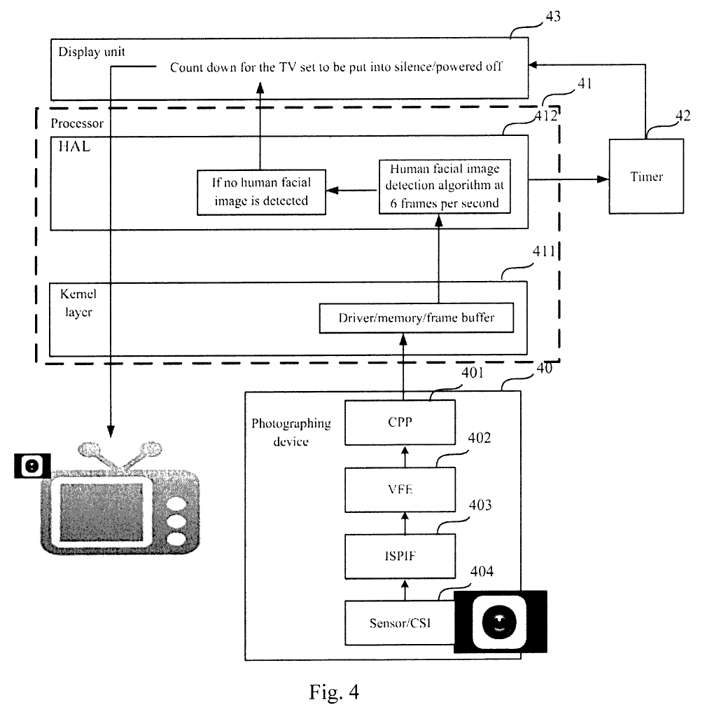

Further to the technical solutions according to the first embodiment to the second embodiment, referring to FIG. 4, some embodiments of the disclosure further provide a terminal including a photographing device 40, a processor 41, and a timer 42, where:

The photographing device 40 is configured to acquire in real time an image in a preset range;

The processor 41 is configured to start the timer 42 if there is no human facial image detected in the acquired image;

The timer 42 is configured to record a length of time; and

The processor 41 is further configured to close the terminal if a length of time recorded by the timer reaches a first preset length of time, and there is no human facial image detected in the image acquired throughout the length of time recorded by the timer.

Optionally the photographing device 40 can be embodied by an Image Signal Processor (ISP) including a Camera Post Processor (CPP) 401, a Video Front End (VFE) 402, an Image Signal Processor Interface (ISPIF), and a Sensor or CMOS Sensor Interface (CSI) 404, where all the components of the photographing device 40 cooperate with each other to acquire the image in the preset range.

Optionally the processor 41 is further configured, before the image in the preset range is acquired in real time, to determine a job at the current instance of time, and if the job does not belong to a preset set of jobs, to instruct the photographing device 40 to acquire the image in the preset range in real time; and/or to determine a point of time when an instruction was received most lately prior to the current instance of time, and if the length of time from the recorded point of time to the current instance of time is more than a second preset length of time, to instruct the photographing device 40 to acquire the image in the preset range in real time.

Optionally the processor 41 configured to detect a human facial image in the acquired image is configured: to eliminate another interference graphs than a human face in the acquired image using a facial sub-feature technology; and if facial feature values satisfying preset conditions can be extracted from the image from which the interference graphs is eliminated, to determine that there is a human facial image in the acquired image, otherwise, to determine that there is no human facial image in the acquired image.

Optionally the processor 41 configured to extract the facial feature values from the image from which the interference graphs is eliminated is configured: to extract feature points in the image, and contours corresponding to the feature points, where the feature points include at least the eyes, the nose, and the mouth, and the contours corresponding to the respective feature points define closed areas; and to determine the sizes of the areas surrounded by the respective extracted contours respectively, the positions of the respective feature points, and the distances between respective two feature points as the facial feature values in the image.

Optionally the processor 41 configured to determine that the facial feature values satisfy the preset conditions is configured to determine that the facial feature values satisfy the preset conditions if the sizes of the areas surrounded by the respective contours lie in corresponding preset area ranges respectively, the positions of the respective feature points lie in corresponding preset feature point ranges respectively, and the distances between the respective two feature points lie in corresponding distance ranges respectively.

Optionally the processor 41 includes a kernel layer 411 and a Hardware Abstraction Layer (HAL) 412, where the kernel layer 411 includes a driver/memory/frame buffer configured to store the image acquired by the photographing device 40; and the hardware abstraction layer 412 is configured to detect the image for a human facial image using a human facial detection algorithm (e.g., 6 frames per second), and if there is no human facial image detected, to count down for the terminal to be put into silence or powered off.

Furthermore the terminal further includes a display unit 43 configured to present a User Interface (UI) including a virtual keypad. Furthermore the display unit 43 is further configured to display information input by a user, or information provided to the user, and various menus provided by the processor 41, where optionally the display unit 43 includes a display panel. Optionally the display panel can be configured as a Liquid Crystal Display (LCD), an Organic Light-Emitting Diode (OLED), etc. Furthermore the display unit 43 can further include a touch screen (not illustrated) which can overlie the display panel, where if the touch screen detects a touch operation thereon or proximate thereto, then the touch screen will transmit it to the processor 41 for determining the type of the touch event, and thereafter the processor 41 will provide a corresponding visual output on the display panel in response to the type of the touch event. The touch screen and the display panel can operate as two separate components to function to input and output the information, but in some embodiments, the touch screen and the display panel can be integrated to function to input and output the information.

In summary, in the embodiments of the disclosure, the terminal acquires in real time the image in the preset range around the terminal, and if there is no human facial image detected in the acquired image, then the terminal will start the timer; and if the length of time recorded by the timer reaches the first preset length of time, and there is no human facial image detected in the image acquired throughout the length of time recorded by the timer, then the terminal will be closed. With the technical solutions according to the embodiments of the disclosure, the terminal detects a human facial image in the preset range using the human face recognition function, and if there is no human facial image detected throughout the first preset of time, then the terminal will be closed, so that even if the user does not close the terminal, then the terminal can be closed automatically in response to the human face recognition result to thereby save power consumption of the terminal so as to extend the operating period of time and the service lifetime of a battery.

Some embodiments of the disclosure provide a non-transitory computer-readable storage medium storing executable instructions that, when executed by an apparatus for closing a terminal, cause the apparatus to perform the method for closing a terminal according to any aforementioned embodiment.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those ordinarily skilled in the art can appreciate that all or a part of the steps in the methods according to the embodiments described above can be performed by program instructing relevant hardware, or certainly by hardware. Based on that, the technical solutions above, or a part thereof contributing to the prior art can be substantively embodied in a form of a software product, which can be stored in a computer readable storage medium, such as, an ROM/RAM, a magnetic disc, an optical disk etc, and includes some instructions for instructing a computer equipment (may be a PC, a server or a network equipment) to perform a method described by each of embodiments or some parts of the embodiments.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for closing a terminal, comprising:
acquiring, by the terminal, in real time an image in a preset range;
starting, by the terminal, a timer if there is no human facial image detected in an acquired image; and
closing, by the terminal, if a length of time recorded by the timer reaches a first preset length of time, and there is no human facial image detected in the image acquired throughout the length of time recorded by the timer.

2. The method according to claim 1, wherein before the image in the preset range is acquired in real time, the method further comprises:
determining, by the terminal, a job at a current instance of time, and if the job does not belong to a preset set of jobs, then acquiring the image in the preset range in real time; and/or
determining, by the terminal, a point of time when an instruction was received most lately prior to the current instance of time, and if the length of time from the recorded point of time to the current instance of time is more than a second preset length of time, then acquiring the image in the preset range in real time.

3. The method according to claim 1, wherein detecting a human facial image in the acquired image comprises:
eliminating interference graphs than a human face in the acquired image using a facial sub-feature technology; and
if facial feature values satisfying preset conditions can be extracted from the image from which the interference graphs are eliminated, then determining that there is a human facial image in the acquired image, otherwise, determining that there is no human facial image in the acquired image.

4. The method according to claim 2, wherein detecting a human facial image in the acquired image comprises:
eliminating interference graphs than a human face in the acquired image using a facial sub-feature technology; and
if facial feature values satisfying preset conditions can be extracted from the image from which the interference graphs are eliminated, then determining that there is a human facial image in the acquired image, otherwise, determining that there is no human facial image in the acquired image.

5. The method according to claim 3, wherein extracting the facial feature values from the image from which the interference graphs are eliminated comprises:
extracting feature points in the image, and contours corresponding to the feature points, wherein the feature points comprise at least the eyes, the nose, and the mouth, and the contours corresponding to the respective feature points define closed areas; and
determining sizes of the areas surrounded by the respective extracted contours respectively, positions of the respective feature points, and distances between respective two feature points as the facial feature values in the image.

6. The method according to claim 5, wherein determining that the facial feature values satisfy the preset conditions comprises:
determining that the facial feature values satisfy the preset conditions if the sizes of the areas surrounded by the respective contours lie in a corresponding preset area ranges respectively, the positions of the respective feature points lie in a corresponding preset feature point ranges respectively, and the distances between the respective two feature points lie in a corresponding distance ranges respectively.

7. An apparatus for closing a terminal, comprising at least one processor; and
a memory communicably connected with the at least one processor for storing instructions executable by the at least one processor, wherein execution of the instructions by the at least one processor causes the at least one processor to:
acquire in real time an image in a preset range;
start a timer if there is no human facial image detected in an acquired image; and
close the terminal if a length of time recorded by the timer reaches a first preset length of time, and there is no human facial image detected in the image acquired throughout the length of time recorded by the timer.

8. The apparatus according to claim 7, wherein execution of the instructions by the at least one processor causes the at least one processor further to:
before the image in the preset range is acquired in real time, determine a job at a current instance of time, and if the job does not belong to a preset set of jobs, acquire the image in the preset range in real time; and/or
determine a point of time when an instruction was received most lately prior to the current instance of time, and if a length of time from the recorded point of time to the current instance of time is more than a second preset length of time, acquire the image in the preset range in real time.

9. The apparatus according to claim 7, wherein execution of the instructions by the at least one processor causes the at least one processor further to:
eliminate interference graphs than a human face in the acquired image using a facial sub-feature technology; and
if facial feature values satisfying preset conditions can be extracted from the image from which the interference graphs are eliminated, determine that there is a human facial image in the acquired image, otherwise, determine that there is no human facial image in the acquired image.

10. The apparatus according to claim 8, wherein execution of the instructions by the at least one processor causes the at least one processor further to:
eliminate interference graphs than a human face in the acquired image using a facial sub-feature technology; and
if facial feature values satisfying preset conditions can be extracted from the image from which the interference graphs are eliminated, determine that there is a human facial image in the acquired image, otherwise, determine that there is no human facial image in the acquired image.

11. The apparatus according to claim 9, wherein execution of the instructions by the at least one processor causes the at least one processor further to:
extract feature points in the image, and contours corresponding to the feature points, wherein the feature points comprise at least the eyes, the nose, and the mouth, and the contours corresponding to the respective feature points define closed areas; and determine sizes of the areas surrounded by the respective extracted contours respectively, positions of the respective feature points, and distances between respective two feature points as the facial feature values in the image.

12. The apparatus according to claim 11, wherein execution of the instructions by the at least one processor causes the at least one processor further to:
determine that the facial feature values satisfy the preset conditions if the sizes of the areas surrounded by the respective contours lie in a corresponding preset area ranges respectively, the positions of the respective feature points lie in a corresponding preset feature point ranges respectively, and the distances between the respective two feature points lie in a corresponding distance ranges respectively.

13. A non-transitory computer-readable storage medium storing executable instructions that are set to:
acquire in real time an image in a preset range;
start a timer if there is no human facial image detected in an acquired image; and
close the terminal if a length of time recorded by the timer reaches a first preset length of time, and there is no human facial image detected in the image acquired throughout the length of time recorded by the timer.

14. The non-transitory computer-readable storage medium according to claim 13, wherein the executable instructions that are further set to:
before the image in the preset range is acquired in real time, determine a job at a current instance of time, and if the job does not belong to a preset set of jobs, acquire the image in the preset range in real time; and/or
determine a point of time when an instruction was received most lately prior to the current instance of time, and if a length of time from the recorded point of time to the current instance of time is more than a second preset length of time, acquire the image in the preset range in real time.

15. The non-transitory computer-readable storage medium according to claim 13, wherein the executable instructions that are further set to:
eliminate interference graphs than a human face in the acquired image using a facial sub-feature technology; and
if facial feature values satisfying preset conditions can be extracted from the image from which the interference graphs are eliminated, determine that there is a human facial image in the acquired image, otherwise, determine that there is no human facial image in the acquired image.

16. The non-transitory computer-readable storage medium according to claim 14, wherein the executable instructions that are further set to:
eliminate interference graphs than a human face in the acquired image using a facial sub-feature technology; and
if facial feature values satisfying preset conditions can be extracted from the image from which the interference graphs are eliminated, determine that there is a human facial image in the acquired image, otherwise, determine that there is no human facial image in the acquired image.

17. The non-transitory computer-readable storage medium according to claim 15, wherein the executable instructions that are further set to:
extract feature points in the image, and contours corresponding to the feature points, wherein the feature points comprise at least the eyes, the nose, and the mouth, and the contours corresponding to the respective feature points define closed areas; and determine sizes of the areas surrounded by the respective extracted contours respectively, positions of the respective feature points, and distances between respective two feature points as the facial feature values in the image.

18. The non-transitory computer-readable storage medium according to claim 17, wherein the executable instructions that are further set to:
determine that the facial feature values satisfy the preset conditions if the sizes of the areas surrounded by the respective contours lie in a corresponding preset area ranges respectively, the positions of the respective feature points lie in a corresponding preset feature point ranges respectively, and the distances between the respective two feature points lie in a corresponding distance ranges respectively.
